(19) United States
(12) Patent Application Publication
(10) Pub. No.: US 2012/0075547 A1
(43) Pub. Date: Mar. 29, 2012

(54) OPTICAL MEMBER AND LIQUID CRYSTAL DISPLAY DEVICE HAVING THE SAME

(76) Inventors: Iori Aoyama, Osaka (JP); Katsumi Kondoh, Osaka (JP)

(21) Appl. No.: 13/375,941

(22) PCT Filed: Feb. 24, 2010
(86) PCT No.: PCT/JP2010/001256

§ 371 Date: Dec. 2, 2011

(30) Foreign Application Priority Data
Jun. 12, 2009 (JP) 2009-141596

(51) Int. Cl. G02F 1/1333; G02B 5/00; B32B 5/20

(52) U.S. Cl. 349/56; 428/319.3; 428/212; 428/309.9; 428/315.7; 428/159

(57) ABSTRACT

An optical member is provided which is fabricated at low cost, which has a flat surface, and which allows a larger viewing angle. An optical member (10) includes at least: a first resin layer (3); and a second resin layer (2), the second resin layer (2) containing bubbles (1), the bubbles (1) being present at least at an interface (4) between the first resin layer (3) and the second resin layer (2).

### TECHNICAL FIELD

The present invention relations to optical members and liquid crystal display devices including such optical members. More specifically, the present invention relates to an optical member which is fabricated at low cost, which has a flat surface, and which allows a larger viewing angle (i.e., allows a less-restricted viewing angle) and a liquid crystal display device including such an optical member.

### BACKGROUND ART

In recent years, along with the popularization of information devices, there has been a growing demand for high performance and lower cost of liquid crystal display devices.

An example of higher performance of a liquid crystal display device is to allow a larger viewing angle (i.e., allow a less-restricted viewing angle). The term “viewing angle” here means an index that indicates a range of angles in which a screen image displayed on a liquid crystal display or the like can be seen in the usual or expected way by a viewer looking obliquely at the liquid crystal display or the like, and refers to an angle formed squarely with the range in which the screen image can be seen in the usual or expected way. In the case of a small viewing angle, as the angle at which the screen image is seen becomes inclined from the perpendicular, there is a significant change in color and/or contrast on the screen image or there is a darkening of color on the screen image, with the result that the display image can no longer be recognized.

Conventionally, in order for liquid crystal display devices to have a lager viewing angle and therefore better display quality, improvements have been made in optical members, such as diffusion plates, to be provided in liquid crystal display devices.

For example, Patent Literature 1 discloses a direct-view-type display device having its waveguide separated by a gap region having a lower refractive index than the waveguide. Specifically, as shown in FIG. 12, image display means 122 includes a substrate 124 and a waveguide 128, and a gap region 133 between one side surface 132 of the waveguide 128 and the other side surface 132 is filled with black light-absorbing particles 141. The use of the light-absorbing particles 141 in each gap region 133 of the waveguide allows an increase in contrast of the direct-view-type display device and a reduction in ambient light (outside light) that is reflected to be returned to a viewer. Further, the refractive index of each gap region 133 of the waveguide 128 is lower than the refractive index of the waveguide 128. Examples of a material for the waveguide 128 include a transparent polymer material whose refractive index falls within a range of 1.45 to 1.65, etc. On the other hand, examples of a material for use in each gap region 133 include air, whose refractive index is 1.00, a fluorine polymer material whose refractive index falls within a range of 1.30 to 1.40, etc.

### CITATION LIST

Patent Literature 1

Japanese Translation of PCT International Publication, Tokuhyohei, No. 7-509327 A (Publication Date: Oct. 12, 1995)

### SUMMARY OF INVENTION

### Technical Problem

However, use of air in each gap region 133 in the technique disclosed in Patent Literature 1 causes the gap region to be a space, with the result that the waveguide 128 has its surface shape depressed and raised. Moreover, a liquid crystal display device fabricated by combining such image display means 122 with a liquid crystal display element glitters due to the depressed and raised shapes on the surface of the waveguide 128 and therefore cannot exhibit satisfactory display quality. It should be noted here that the surface of the waveguide 128 can be made flat by filling each gap region 133 (space) with carbon black or the like, but adhesion of the carbon black or the like to the waveguide 128 requires an adhesive layer or a binder resin.

Further, use of a fluorine polymer resin in each gap region 133 in the technique disclosed in Patent Literature 1 results in high cost and a low degree of adhesion of the fluorine polymer material to the waveguide 128 (since the fluorine polymer material has a fluorine group on its surface and therefore has very high water repellency, the degree of adhesion of the fluorine polymer material to another resin is low).

Furthermore, in the case of use of a non-fluorine polymer material with a refractive index of 1.40 or higher in each gap region 133 in the technique disclosed in Patent Literature 1, the transparent polymer material to be used for the waveguide 128 is required to have a high refractive index. Moreover, in order to have a higher refractive index, the transparent polymer material to be used for the waveguide 128 may contain halogen. However, if the transparent polymer material contains halogen, it is yellowish and therefore low in transparency.

As such, the technique disclosed in Patent Literature 1 place restrictions on selection of material for a lager difference in refractive index between the fluorine polymer material to be used in each gap region 133 and the transparent polymer material to be use for the waveguide 128, causes an increase in fabrication cost, and prevents the surface from being flat.

In particular, because of the high fabrication cost, the technique disclosed in Patent Literature 1 is hard to get in operation for development into various applications such as televisions for use in general households.

The present invention has been made in view of the foregoing conventional problems, and it is an object of the present invention to provide a liquid crystal display device which is fabricated at low cost, which has a flat surface, and which allows a larger viewing angle and a liquid crystal display device including such an optical member.

### Solution to Problem

As a result of diligent study of the foregoing problems, the inventors uniquely found that improvements in materials for optical members conventionally used in liquid crystal display devices and the like having optical members joined on top of each other allow fabrication of optical members which are inexpensive and which have flat surfaces, and thus accomplished the present invention.

In order to solve the foregoing problems, an optical member of the present invention is an optical member including at least: a first resin layer; and a second resin layer, the second resin layer containing bubbles, the bubbles being present at least at an interface between the first resin layer and the second resin layer.

It should be noted here that an attempt to totally reflect light incident on the interface from the plane of incidence requires a larger difference in refractive index between the low-refractive-index region and the high-refractive-index region. This places restrictions on selection of material to be contained in each region, and sometimes requires use of a less common special resin.

However, since the optical member of the present invention is configured such that the second resin layer contains bubbles and the bubbles are present at least at the interface between the first resin layer and the second resin layer, it is possible to render the difference in refractive index between the second resin layer and the first resin layer larger even when using a general-purpose resin as a resin to be contained in the first resin layer. This allows the optical member of the present invention to totally reflect light incident on the interface from the plane of incidence. As a result, a liquid crystal display device including the optical member of the present invention can have a larger viewing angle.

Further, the optical member of the present invention allows a general-purpose resin to be used as a resin to be contained in the first resin layer, thus allowing a reduction in fabrication cost.

Furthermore, since the optical member of the present invention is configured such that the second resin layer is not mere air but a resin containing bubbles, it is possible to make the surface (pattern formation surface) flat.

### Advantageous Effects of Invention

As described above, an optical member of the present invention is an optical member including at least: a first resin layer; and a second resin layer, the second resin layer containing bubbles, the bubbles being present at least at an interface between the first resin layer and the second resin layer.

Therefore, the optical member of the present invention brings about an effect of achieving low fabrication cost, a flat surface, and a larger viewing angle.

### BRIEF DESCRIPTION OF DRAWINGS

FIG. 1 is a cross-sectional view showing a configuration of a liquid crystal display device according to an embodiment of the present invention.

FIG. 2 is a cross-sectional view showing a configuration of an optical member according to an embodiment of the present invention.

FIG. 3 includes (a) a cross-sectional view showing a configuration of a main part of a conventional optical member and (b) a cross-sectional view showing a configuration of a main part of an optical member according to an embodiment of the present invention.

FIG. 4 is a cross-sectional view showing a configuration of a main part of an optical member according to an embodiment of the present invention.

FIG. 5 is a cross-sectional view showing a configuration of a main part of an optical member according to an embodiment of the present invention.

FIG. 6 is a cross-sectional view showing a configuration of a main part of an optical member according to an embodiment of the present invention.

FIG. 7 is a perspective view showing a configuration of an optical member according to an embodiment of the present invention.

FIG. 8 is a perspective view showing a configuration of an optical member according to an embodiment of the present invention.

FIG. 9 is a cross-sectional view showing a configuration of a main part of an optical member according to an embodiment of the present invention.

FIG. 10 is a cross-sectional view showing a configuration of an optical member according to another embodiment of the present invention.

FIG. 11 is a cross-sectional view showing a configuration of an optical member according to still another embodiment of the present invention.

FIG. 12 is a cross-sectional view showing a configuration of a conventional optical member.

### DESCRIPTION OF EMBODIMENTS

### Embodiment 1

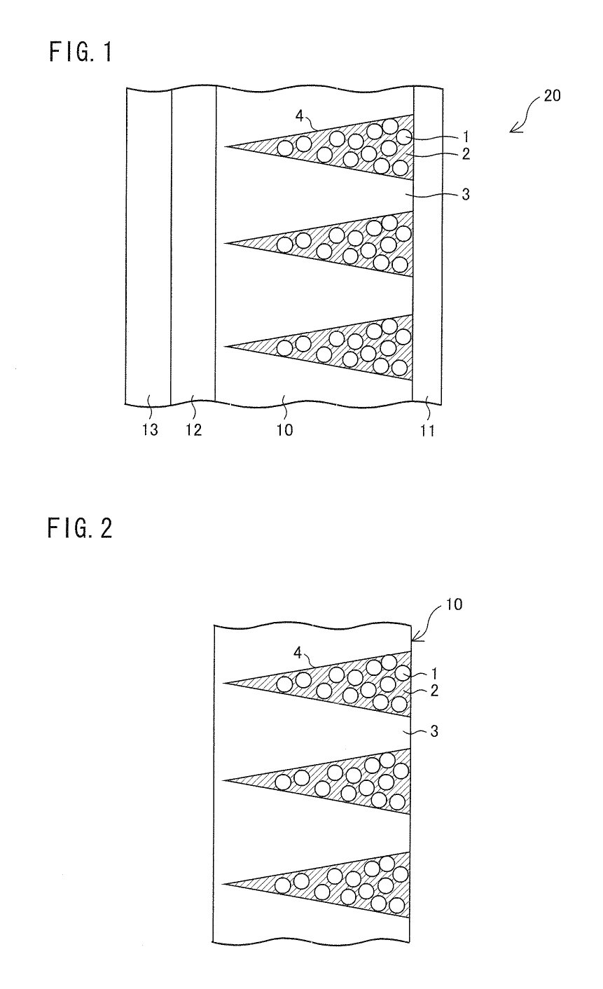

An embodiment of the present invention is described below with reference to FIGS. 1 through 9. It should be noted that the present invention is not to be limited to this embodiment. The dimensions of, materials for, shapes of, and relative arrangement of components described in this embodiment are not intended to limit the scope of the present invention solely thereto, unless specifically described, and serve solely for illustrative purposes. It should be noted that the range of “A to B” in this specification indicates “A or more to B or less”.

FIG. 1 is a cross-sectional view schematically showing a configuration of a liquid crystal display device 20 according to the present embodiment. As shown in FIG. 1, the liquid crystal display device 20 mainly includes an optical member (such as a light diffusion layer or a light diffusion plate) 10, a surface-treated film 11, a substrate 12, and a liquid crystal display element 13. It should be noted that a case where the substrate 12 is included in the liquid crystal display element 13 is also encompassed in the present invention.

Furthermore, as shown in FIGS. 1 and 2, the optical member 10 mainly has bubbles 1, a low-refractive-index region (second resin layer) 2, and a high-refractive-index region (first resin layer) 3. It should be noted that the second resin layer 2 and the first resin layer 3 may contain an identical resin. In that case, the refractive index of a portion of the second resin layer 2 other than the bubbles 1 and the refractive index of the first resin layer are equal. Moreover, formed between the bubbles 1 in the low-refractive-index region 2 and the resin in the high-refractive-index region 3 is an interface 4.

<Optical Member>

The optical member 10 includes at least a first resin layer 3 and a second resin layer 2. The second resin layer 2 contains bubbles 1, and the bubbles 1 are present at least at an interface 4 between the first resin layer 3 and the second resin layer 2.

Further, the optical member 10 is preferably configured such that the second resin layer 2 is a region that is lower in refractive index than the first resin layer 3.

The interface 4 is inclined preferably at 6 to 21 degrees, or more preferably at 6 to 20 degrees, to a direction in which light entering through a plane of incidence travels.

As mentioned above, the upper limit for the inclination of the interface 4 to the direction in which light entering through the plane of incidence travels (hereinafter also referred to simply as “upper limit”) is derived from conditions under which light having entered the optical member at an angle perpendicular to the plane of incidence and having been reflected by the interface is emitted from the first resin layer. Obtaining θ on the assumption that n1 is the refractive index of 1.55 of a more common resin gives θ=approximately 40 degrees. Therefore, when the upper limit for the inclination of the interface is set to include up to this angle, the inclination of the interface is 20 degrees or smaller.

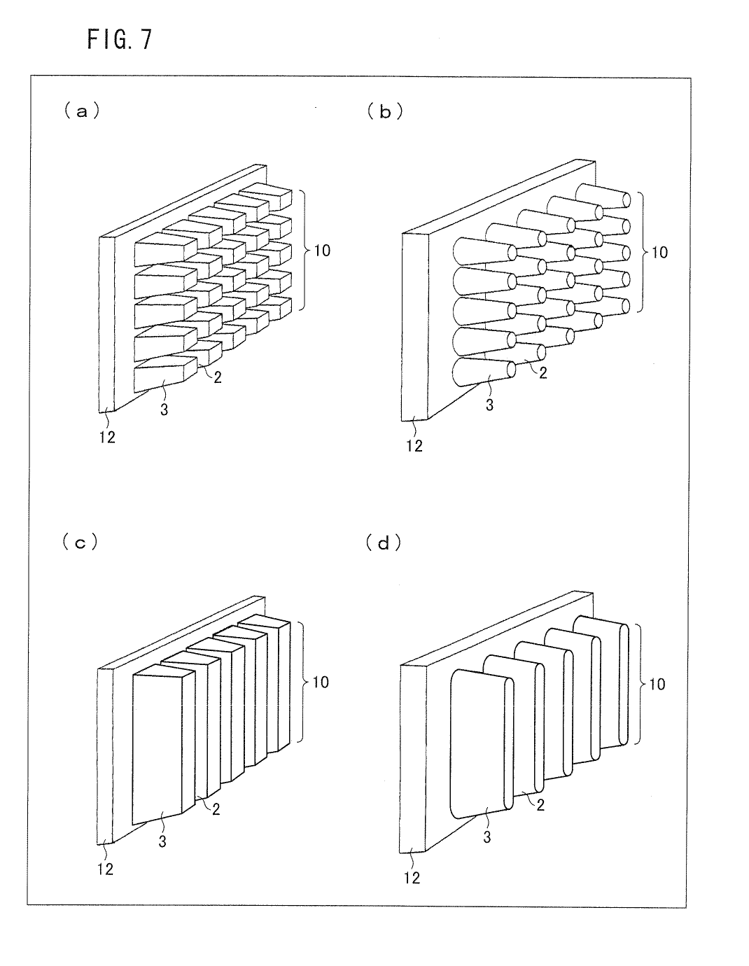

The optical member 10 is, for example, in any one of the shapes shown in (a) through (d) of FIG. 7.

The optical member (optical sheet) in the present invention serves to uniformize and focus light emitted from a backlight or the like and irradiate the outside (in some cases, the liquid crystal display panel) with the light. Examples of the optical member include a diffusion plate (diffusion sheet) that scatters light while focusing it, a lens sheet that improves the luminance of light in a frontward direction (i.e. in the opposite direction from the backlight or the like), a polarization reflecting sheet that improves the luminance of a liquid crystal display device or the like by reflecting one polarized component of light and transmitting the other polarized component, etc. It should be noted that the optical member may be constituted by a plurality of sheets joined on top of each other.

<Bubbles>

In the present invention, examples of the resin to be used for the second resin layer 2 containing the bubbles 1 include microcellular resin foam, nanocell resin foam, etc. It should be noted that nanocell resin foam is especially preferable because it allows a reduction in fabrication time.

The microcellular resin foam for use in the present invention is resin form, containing fine and uniform bubbles, which is produced by dissolving a large amount of gas such as carbon dioxide in a base resin (described later), causing a decrease in gas solubility through an abrupt change in pressure, temperature, etc., and using the decrease in gas solubility as driving force. A specific example of microcellular resin foam is shown in U.S. Pat. No. 4,473,665.

Further, the nanocell resin foam for use in the present invention is resin foam, containing fine and uniform bubbles, which is produced by introducing a foaming-gas-decomposing functional group in advance into a base resin (described later) and initiating a reaction through irradiation with ultraviolet rays or the like.

Specifically, the nanocell resin foam is produced by any one of the following methods: (1) a method including: an irradiating step of irradiating, with an active energy beam, an expandable composition containing an acid-generating agent that generates an acid by the action of the active energy beam or a base-generating agent that generates a base by the action of the active energy beam and containing a compound having a decomposing expandable functional group that react with an acid or a base to decompose and desorb one or more types of low-boiling volatile substance; and a foaming step of foaming the expandable composition under controlled pressure in a range of temperatures in which the low-boiling volatile substance is decomposed and desorbed; (2) a method including a molding step of molding the expandable composition at the same time as or at any point in time before the foaming step; (3) a method including a molding step that is executed before the irradiating step; (4) a method including the molding step that is executed between the irradiating step and the foaming step; (5) a method including the foaming step and the molding step that are executed at the same time; and (6) a method including: an foaming step of irradiating, with an active energy beam, an expandable composition containing an acid-generating agent that generates an acid by the action of the active energy beam or a base-generating agent that generates a base by the action of the active energy beam and containing a compound having a decomposing expandable functional group that react with an acid or a base to decompose and desorb one or more types of low-boiling volatile substance, in a range of temperatures in which the low-boiling volatile substance is decomposed and desorbed and, at the same time, foaming the expandable composition under controlled pressure. An example of nanocell resin foam is detailed in Japanese Patent Application Publication, Tokukai, No. 2006-124697.

The median value of size distribution of the bubbles 1 is preferably 10 μm or smaller, or more preferably 1 μm or smaller. Examples of resins containing bubbles of 10 μm or smaller include microcellular resin foam, etc., and examples of resins containing bubbles of 1 μm or smaller include nanocell resin foam, etc.

The size of each bubble 1 is described in detail with reference to FIG. 9. It should be noted here that it is generally said that from the point of view of moire reduction, it is preferable that the pitch of a cyclic pattern is ¾ or less of that of another cyclic pattern. Moire reduction means reduction of moire (interference fringes in light). An example of moire reduction is to reduce the appearance of unpleasant wave-like patterns caused by the occurrence with a cycle of portions of scanner input which are picked up as dots and those which are not picked up as dots. Since the largest liquid crystal display element in current use has a 100-inch full-HD panel whose pixel pitch (cyclic pitch) is approximately 380 μm, the cyclic pitch of an optical member to be combined with the liquid crystal display element is approximately 280 μm or less. Of course, the cyclic pitch of a 40-inch or 60-inch general household panel is less than or equal to the above cyclic pitch.

With such a cyclic pitch, common resin foam such as expanded polystyrene has a size of several hundreds micrometers, which is lager than a wedge-shaped portion (whose base is approximately in the order of approximately 150 μm or less), and therefore is not suitable. Therefore, in order to make uniform bubbles in the wedge-shaped portion described later, it is preferable that the bubbles have a size of several micrometers or smaller (the median value of size distribution of the bubbles be 1 μm or less). However, even if the bubbles have a size of several micrometers or smaller, it is impossible to achieve adequate characteristics (such as reflection of light), unless the bubbles are densely present at the interface. This is because the low-refractive-index region forms the interface with the high-refractive-index region with its refractive index being not the refractive index 1.00 of the bubbles (air) but the refractive index of the base resin. Further, even if the low-refractive-index region is densely filled with the bubbles, there exists a portion on the interface to which the bubbles do not adhere, where there occurs a loss of reflection (e.g., see FIG. 9). In order to solve such a problem, it is preferable that the size of each bubble be reduced substantially to the wavelength of light.

In general, light is not very high in resolution with respect to a direction of amplitude of electromagnetic wave and does not sense an interface (reflecting surface) in a periodic structure smaller than or equal to the wavelength of the light. Therefore, the light senses an average of the refractive index of a portion where the structure is and the refractive index of a portion where the structure is not. This principle is employed to achieve the absence of reflection, examples of which include moth eyes and radio anechoic chambers. These prevent reflection by using a structure (in the shape of a pyramid or a cone) smaller than or equal to the wavelength to prevent the interface of the structure from being sensed. However, while there occurs no reflection due to the structure at the interface, there occurs reflection due to the difference in refractive index.

On the basis of this principle, when the size of the bubbles in the resin foam is rendered smaller than or equal to the wavelength of light, the light senses an average of the refractive index of the bubbles and the refractive index of the base resin. The average refractive index depends on the ratio between the bubbles and the base resin per unit length. In a case Where the bubbles adhere densely to the interface, the average refractive index takes on a value close to the refractive index of the bubbles, and in a case where the bubble do not adhere densely to the interface, the average refractive index takes on a value close to the refractive index of the base resin.

As described above, in view of the size of a wedge shape in the low-refractive-index region, it is preferable that the size of the bubbles in the resin foam be several micrometers or smaller. Furthermore, from the point of view of efficiency in the use of light, it is preferable that the size of the bubbles in the resin foam be equal to the wavelength of the light or not larger than 1 μm, which is smaller than or equal to the wavelength of the light.

It should be noted here that in the case where “the cyclic pitch of an optical member is approximately 280 μm or less”, it is preferable, in view of the size of a shape (such as a wedge shape) of the second resin layer, that the size of the bubbles be 10 μm or smaller based on common sense, and it is more preferable, in view of a loss of reflection of light, that the size of the bubbles be 1 μm or smaller.

In the present invention, the resin containing the bubbles 1 may or may not have light-absorbing properties.

<Resin>

Resins for use in the present invention are not particularly limited, examples of which include common resins containing methyl acrylate, ethyl acrylate, lauryl acrylate, stearyl acrylate, 2-ethylhexyl acrylate, 2-hydroxyethyl acrylate, 2-hydroxyethyl methacrylate, 2-hydroxypropyl acrylate, 2-hydroxypropyl methacrylate, 2-hydroxybutyl acrylate, 2-hydroxybutyl methacrylate, tetrahydrofurfuryl acrylate, tetrahydrofurfuryl methacrylate, caprolactone modified tetrahydrofurfuryl acrylate, cyclohexyl acrylate, cyclohexyl methacrylate, dicyclohexyl acrylate, isobornyl acrylate, isobornyl methacrylate, benzyl acrylate, benzyl methacrylate, ethoxydiethylene glycol acrylate, methoxytriethylene glycol acrylate, methoxypropylene glycol acrylate, phenoxypolyethylene glycol acrylate, phenoxypolypropylene glycol acrylate, ethyleneoxide modified phenoxy acrylate, N,N-dimethylaminoethyl acrylate, N,N-dimethylaminoethyl methacrylate, 2-ethylhexylcarbitol acrylate, ω-carboxypolycaprolactone monoacylate, monohydroxyethyl phthalate acrylate, acrylic acid dimer, 2-hydroxy-3-phenoxypropyl acrylate, acrylic acid-9,10-epoxidized oleyl, ethylene glycol maleate monoacrylate, dicyclopentenyloxyethylene acrylate, acrylate of caprolactone adduct of 4,4-dimethyl-1,3-dioxolan, acrylate of caprolactone adduct of 3-methyl-5,5-dimethyl-1,3-dioxolan, polybutadiene acrylate, ehtyleneoxide modified phenoxylated phosphoric acid acrylate, ethanediol diacrylate, ethanediol dimethacrylate, 1,3-propanediol diacrylate, 1,3-propanediol dimethacrylate, 1,4-butanediol diacrylate, 1,4-butanediol dimethacrylate, 1,6-hexanediol diacrylate, 1,6-hexanediol dimethacrylate, 1,9-nonanediol diacrylate, 1,9-nonanediol dimethacrylate, diethylene glycol diacrylate, polyethylene glycol diacrylate, polyethylene glycol dimethacrylate, polypropylene glycol diacrylate, polypropylene glycol dimethacrylate, neopentyl glycol diacrylate, 2-butyl-2-ethylpropanediol diacrylate, ethyleneoxide modified bisphenol A diacrylate, polyethyleneoxide modified bisphenol A diacrylate, polyethyleneoxide modified hydrogenated bisphenol A diacrylate, propyleneoxide modified bisphenol A diacrylate, polypropyleneoxide modified bisphenol A diacrylate, ethyleneoxide modified isocyanuric acid diacrylate, pentaerythritol diacrylate monostearate, 1,6-hexanediol diglycidyl ether acrylic acid adduct, polyoxyethylene epichlorohydrin modified bisphenol A diacrylate, trimethylolpropane triacrylate, ethyleneoxide modified trimethylolpropane triacrylate, polyethyleneoxide modified trimethylolpropane triacrylate, propyleneoxide modified trimethylolpropane triacrylate, polypropyleneoxide modified trimethylolpropane triacrylate, pentaerythritol triacrylate, ethyleneoxide modified isocyanuric acid triacrylate, ethyleneoxide modified glycerol triacrylate, polyethyleneoxide modifiedglycerol triacrylate, propyleneoxide modified glycerol triacrylate, polypropyleneoxide modified glycerol triacrylate, pentaerythritol tetraacrylate, ditrimethylolpropane tetraacrylate, dipentaerythritol tetraacrylate, dipentaerythritol pentaacrylate, dipentaerythritol hexaacrylate, caprolactone modified dipentaerythritol hexaacrylate, polycaprolactone modified dipentaerythritol hexaacrylate, etc.

However, none of these resins implies any limitation, and it is also possible to use optically transparent resins such as polycarbonate resin, polystyrene resin, polyethylene resin, butadiene resin, epoxy resin, etc.

<Second Resin Layer (Low-Refractive-Index Region)>

The second resin layer (low-refractive-index region) 2 of the present invention contains a resin containing bubbles 1.

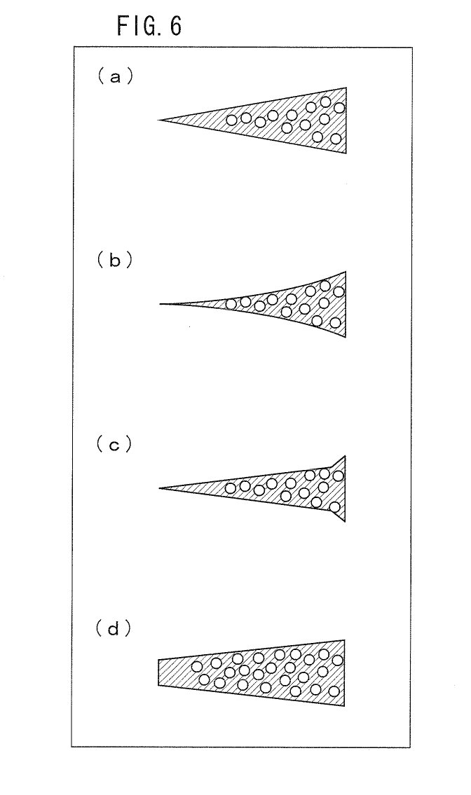

The low-refractive-index region 2 is not particularly limited in shape as long as the interface 4 is inclined at 6 to 21 degrees to the direction in which light entering through the plane of incidence travels. The low-refractive-index region 2 is, for example, in any one of the shapes shown in (a) through (d) of FIG. 6.

In the present invention, the first resin layer (high-refractive-index region) and the second resin layer (low-refractive-index region) may contain an identical resin.

<First Resin Layer (High-Refractive-Index Region)>

The first resin layer (high-refractive-index region) 3 of the present invention contains a resin.

The high-refractive-index region 3 of the present invention is configured such that the refractive index of a high-refractive-index side of the interface 4 between the low-refractive-index region 2 and the high-refractive-index region 3 is higher than the refractive index of a low-refractive-index side of the interface 4. That is, the high-refractive-index region 3 of the present invention contains a common material (resin) whose refractive index is higher than 1.00.

For transmission of light, it is preferable that the material (resin) contained in the high-refractive-index region be a transparent material (resin).

As mentioned above, the optical member 10 is, for example, in any one of the shapes shown in (a) through (d) of FIG. 7. Specifically, the shape of the high-refractive-index region 3 in the optical member 10 is not particularly limited as long as the interface 4 is inclined at 6 to 21 degrees to the direction in which light entering through the plane of incidence travels. Examples of the shape include a quadrangular pyramidal shape, a conical shape, etc. Further, the shape of the high-refractive-index region 3 may be a striped shape composed of a plurality of quadrangular pyramidal shapes, conical shapes, or the like joined together one after another. Further, a cross-section of the shape of the high-refractive-index region 3 has a wedge shape or the like.

<Interface>

The interface 4 in the present invention means a surface formed by the plurality of bubbles 1 being arranged inside the second resin layer (low-refractive-index region) 2 in contact with (along) the first resin layer (high-refractive-index region) 3.

In the present invention, there occurs a difference in refractive index at the interface 4, so that light entering the interface through the plane of incidence is totally reflected. This allows the liquid crystal display device 20 including the optical member of the present invention to have a larger viewing angle.

<Foaming Initiator>

The second resin layer 2 for use in the present invention may be made to contain the bubbles 1 by bringing the resin into contact with a foaming initiator on the interface 4.

The foaming initiator for use in the present invention is of a thermal decomposition type, a photodecomposition type, etc., and is preferably of a photodecomposition type. A photodecomposition foaming initiator is decomposed by an active energy beam such as ultraviolet rays or an electron beam to emit gas such as nitrogen. Examples of photodecomposition foaming initiators include a compound having an azido group such as p-azidobenzaldehyde, a compound having a diazo group such as p-diazophenylamine, etc.

Alternatively, the foaming initiator for use in the present invention may be an organic compound that generates gas in the process of polymerization, examples of which include polyurethane, etc. Polyurethane is a product of polymerization of polyol and polyisocyanate, and generates carbon dioxide gas in the process of polymerization reaction to form foam.

Use of such a foaming initiator allows selectively facilitating foaming at the interface 4. In the case of use of a photodecomposition foaming initiator, it is only necessary to irradiate a selected portion with an active energy beam. Alternatively, in the case of use of a polymerization foaming initiator, it is only necessary to mix only one type of resin among plural types of resin.

<Surface-Treated Film>

It is preferable that the optical member 10 have a surface-treated film 11 laminated on a surface opposite to the plane of incidence.

Examples of the surface-treated film 11 include an AG (anti-glare) film, an LR (low-reflection) film, etc.

<Substrate>

The liquid crystal display device includes a substrate 12. As the substrate 12, a conventional publicly-known substrate for use in a liquid crystal display device can be used.

<Liquid Crystal Display Element>

The liquid crystal display device 20 includes a liquid crystal display element 13. As the liquid crystal display element 13, a conventional publicly-known liquid crystal display element for use in a liquid crystal display device can be used. An example of such a publicly-known liquid crystal display element is one which includes liquid crystals, a polarizer, a waveguide, a reflector, a light source, etc.

<Liquid Crystal Display Device>

The liquid crystal display device 20 includes an optical member 10. Further, it is preferable that the liquid crystal display device 20 include a plurality of optical members.

<Specific Configuration of an Optical Member>

An optical member 10 having bubbles 1, a low-refractive-index region 2, and a high-refractive-index region 3 is described below in detail.

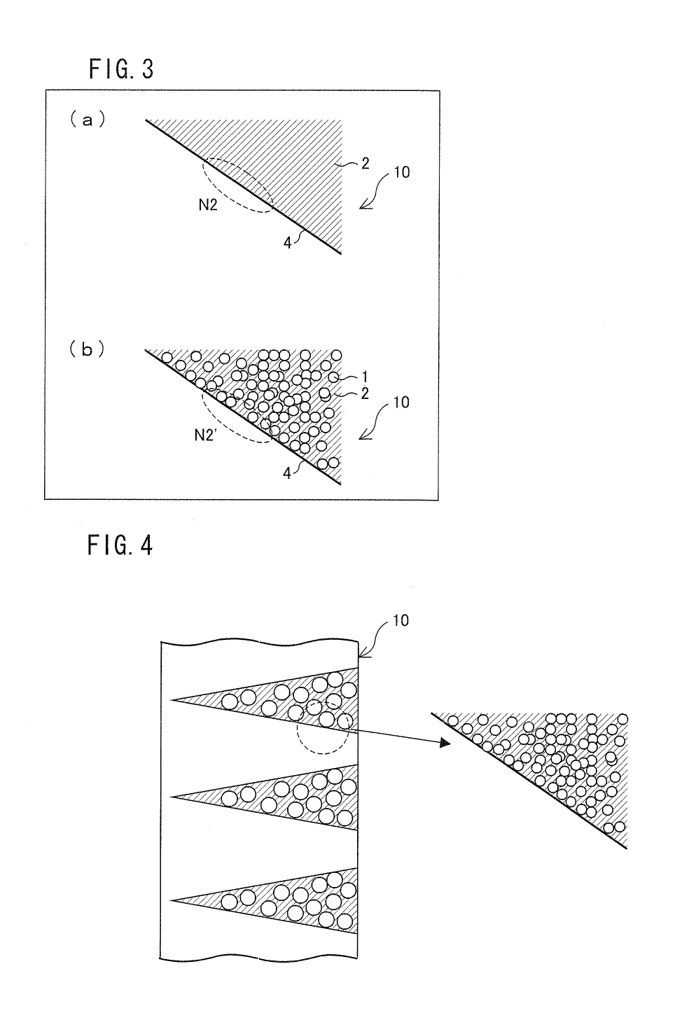

(a) of FIG. 3 is a cross-sectional view showing a configuration of a main part of a conventional optical member, and (b) of FIG. 3 and FIG. 4 are cross-sectional views showing a configuration of a main part of an optical member 10 according to the present embodiment.

Specifically, in (a) of FIG. 3, the optical member 10 contains an unexpanded low-refractive-index resin on a side of the interface 4 that faces the low-refractive-index region 2, and the low-refractive-index resin is in close contact with the interface 4. That is, in (a) of FIG. 3, there exists no air layer at the interface 4.

In (b) of FIG. 3, on the other hand, the optical member 10 contains resin foam (resin containing bubbles 1) on a side of the interface 4 that faces the low-refractive-index region 2, and the bubbles 1 in the resin foam are arranged in contact with (along) the interface 4. That is, in (b) of FIG.

3, there exists an air layer at the interface 4.

Further, in (a) of FIG. 3, light entering through the plane of incidence senses a difference in refractive index between the high-refractive index resin (e.g., whose refractive index is N1) and the low-refractive index resin (e.g., whose refractive index is N2) at the interface 4.

In (b) of FIG. 3, on the other hand, when the bubbles 1 are small in size (e.g., in a case where the size is 10 μm or smaller), the bubbles 1 in the resin foam are densely arranged along the interface 4, so that light entering through the plane of incidence senses a difference in refractive index between the high-refractive-index resin (e.g., whose refractive index is N1) and an average refractive index (which is N2′, where N2′<N2). It should be noted here that the average refractive index (N2′) means an average of the refractive indices of the low-refractive-index resin (e.g., whose refractive index is N2) and of the bubbles 1 (e.g., whose refractive index is N3).

N2′ is smaller than N2 (N2′<N2) because when the bubbles 1 has a size as large as the wavelength of light, the light senses an average of the refractive index (N3) of the bubbles 1 and the refractive index (N2) of the low-refractive-index resin.

On the other hand, in a case where the bubbles 1 in the resin foam are densely arranged along the interface 4 (e.g., the resin foam is in a sponge-like state) even when the bubbles 1 are large in size (e.g., in a case where the size is larger than 10 μm to 100 μm or smaller), a layer of bubbles 1 looks as if it covered a surface of the high-refractive-index resin. This makes it OK to treat the refractive index N1 as N3, so that light entering through the plane of incidence senses a difference in refractive index between the high-refractive-index resin (N1) and the bubbles 1 (N3) at the interface 4.

It should be noted that gas in the bubbles 1 varies depending on how a resin is foamed to form resin foam. Use of air (whose refractive index is 1.00) allows a significant reduction in refractive index of the low-refractive-index resin.

This makes it possible, as a result, to treat the low-refractive-index resin as air or a material close in refractive index to air, and to use not an expensive material but a general-purpose material (resin) as the high-refractive index resin. This makes it possible to remove restrictions placed on designing by material (resin) and reduce fabrication cost.

In this specification, the high-refractive index resin may refer to a portion of the low-refractive-index resin other than the bubbles 1. That is, the low-refractive-index region 2 and the high-refractive-index region 3 may be made of the same material (resin) except for the presence or absence of the bubbles 1.

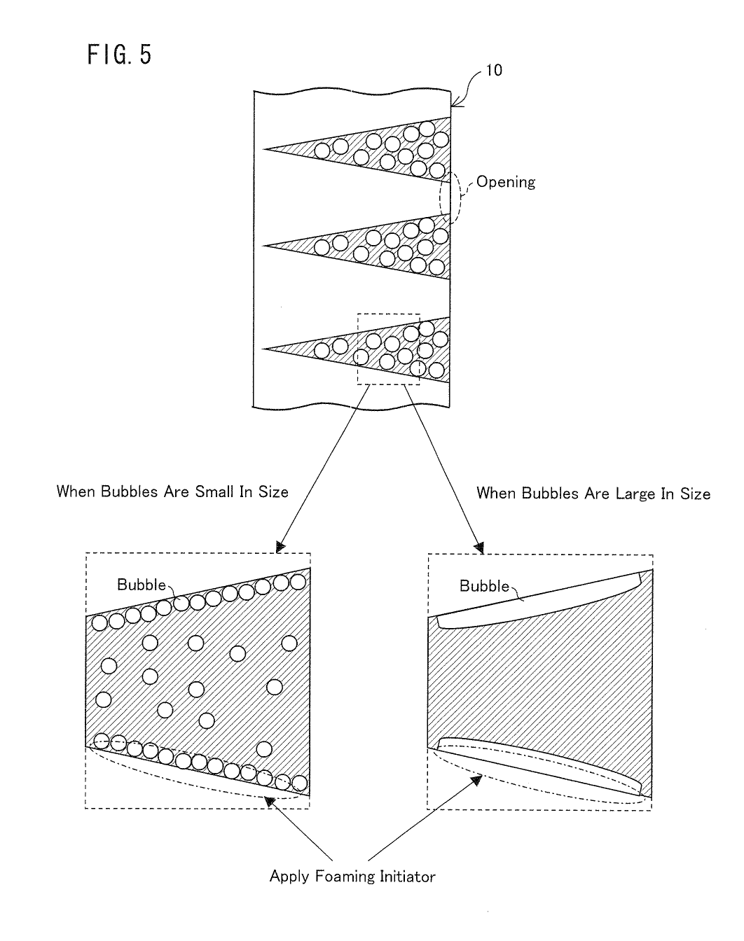

FIG. 5 is a cross-sectional view showing a configuration of a main part of an optical member 10 according to the present embodiment. In FIG. 5, the clause “WHEN BUBBLES ARE SMALL IN SIZE” means that the bubbles have a size of 10 μm or smaller, and the clause “WHEN BUBBLES ARE LARGE IN SIZE” means that the bubbles have a size of larger than 10 μm to 100 μm or smaller.

Specifically, the bubbles 1 in the resin foam for use in the low-refractive-index region 2 bring about the effects of the present invention when they are densely formed at the interface 4 between the low-refractive-index region 2 and the high-refractive-index region 3. Conversely, the bubbles 1 bring about the effects of the present invention as long as they are densely formed at the interface 4 between the low-refractive-index region 2 and the high-refractive-index region 3, even when the bubbles 1 are not densely formed in a portion of the low-refractive-index region 2 other than the interface 4 (e.g., a central portion of the low-refractive-index region 2). This is because a portion other than the interface between the low-refractive-index region 2 and the high-refractive-index region 3 has no influence on the characteristics of the optical member 10.

As shown in FIG. 5, when the bubbles 1 are small in size (i.e., in a case where the size is 10 μm or smaller), they bring about the effects of the present invention when they are densely formed at the interface 4 between the low-refractive-index region 2 and the high-refractive-index region 3. It should be noted that even in a case where the bubbles 1 are densely formed at the interface 4 between the low-refractive-index region 2 and the high-refractive-index region 3, the interface 4 is not wholly covered with the bubbles 1 but there partly exists a place of contact between the low-refractive-index region 2 and the high-refractive-index region 3. Therefore, the adhesion between the low-refractive-index region 2 and the high-refractive-index region 3 is maintained.

On the other hand, when the bubbles 1 are large in size (i.e., in a case where the size is larger than 10 μm), they can be made to bring about the effects of the present invention by selectively induce foaming at the interface 4 between the low-refractive-index region 2 and the high-refractive-index region 3. Selective induction of foaming at the interface 4 is achieved by applying a foaming initiator to the interface 4, filling the low-refractive-index region 2 with a resin, and then starting foaming, in some cases, by irradiating the resin with heat or light (ultraviolet rays, etc). It should be noted that it is also possible to apply the foaming initiator to the interface 4 between the low-refractive-index region 2 and the high-refractive-index region 3 when the bubbles 1 are small in size.

The foaming initiator may be applied to a portion other than the interface 4, such as an opening or the like in the optical member 10. In a case where the foaming initiator has been applied to a portion other than the interface 4, it is only necessary to cure the resin with which the low-refractive-index region 2 has been filled and then remove the foaming initiator by washing the optical member 10.

In a case where the bubbles 1 are sparsely present at the interface 4 between the low-refractive-index region 2 and the high-refractive-index region 3, there occurs a loss of reflection because light is not reflected by a portion in which no bubbles 1 exist. In a case where the bubbles 1 are large in size, the bubbles 1 are likely to be sparsely present at the interface 4 and therefore prone to a state in which the bubbles 1 are not in close contact with one another or in which the bubbles 1 are in close contact with one another but are low in adhesion to the resin used in the high-refractive-index region 3.

(a) through (d) of FIG. 6 are each a cross-sectional view showing a configuration of a main part of an optical member 10 according to the present embodiment or, specifically, a cross-sectional view showing the shape of the low-refractive-index region 2 in the optical member 10.

The low-refractive-index region 2 is not particularly limited in shape as long as the interface 4 between the low-refractive-index region 2 and the high-refractive-index region 3 is inclined at 6 to 21 degrees to the direction in which light entering through the plane of incidence travels. The low-refractive-index region 2 is, for example, in any one of the shapes shown in (a) through (d) of FIG. 6.

It is preferable that the interface 4 between the low-refractive-index region 2 and the high-refractive-index region 3 be inclined at 6 to 20 degrees to the direction in which light entering through the plane of incidence travels.

(a) through (d) of FIG. 7 are each a perspective view showing a configuration of an optical member 10 according to the present embodiment. The optical member 10 is not particularly limited in shape, but is, for example, in any one of the shapes shown in (a) through (d) of FIG. 7.

Specifically, examples of the shape of the high-refractive-index region 3 in the optical member 10 include a quadrangular pyramidal shape, a conical shape, etc. Further, the shape of the high-refractive-index region 3 may be a striped shape composed of a plurality of quadrangular pyramidal shapes, conical shapes, or the like joined together one after another. Further, a cross-section of the shape of the high-refractive-index region 3 has a wedge shape or the like. It should be noted that as mentioned above, the shape of the low-refractive-index region 2 in the optical member 2 is, for example, any one of the shapes shown in (a) through (d) of FIG. 6.

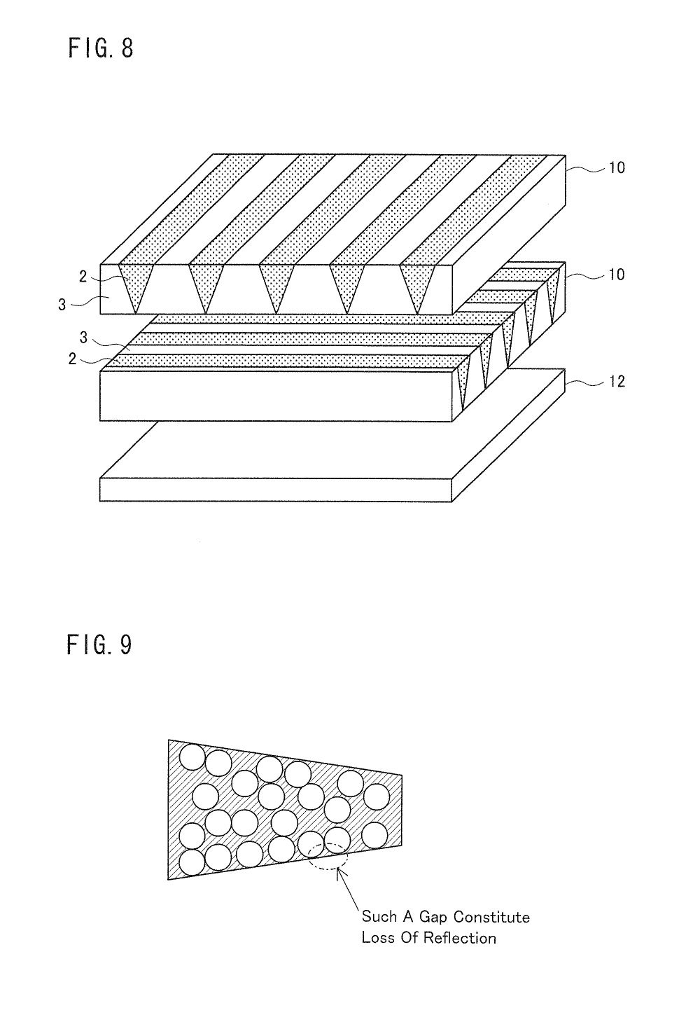

FIG. 8 is a perspective view showing a configuration of optical members 10 according to the present embodiment, specifically, of two optical members according to the present embodiment joined on top of each other.

In a case where the shape of the high-refractive-index region 3 in an optical member 10 is a striped shape composed of a plurality of quadrangular pyramidal shapes, conical shapes, or the like joined together one after another, light is diffused only in a direction perpendicular to the direction of stripes. That is, light is not diffused in a direction parallel to the direction of stripes. Therefore, even if combined with a liquid crystal display element, the optical member 10 can only improve the viewing angle characteristics in the direction in which light is diffused.

Even in a case where the shape of the high-refractive-index region 3 in an optical member 10 is a striped shape composed of a plurality of quadrangular pyramidal shapes, conical shapes, or the like joined together one after another, two optical members 10 are joined together so that their directions of stripes are substantially perpendicular to each other, whereby when combined with a liquid crystal display element, the optical members 10 can improve the viewing angle characteristics in all directions.

It should be noted here that an attempt to totally reflect light incident on the interface between the bubbles 1 in the low-refractive-index region 2 and the resin layer in the high-refractive-index region 3 from the plane of incidence so that the light is efficiently reflected requires a larger difference in refractive index between the low-refractive-index region 2 and the high-refractive-index region 3. This places restrictions on selection of material to be contained in each region, and requires use of a less common special resin.

In the present invention, the low-refractive-index region 2 contains resin foam, and since the resin foam can be treated as air or a material close in refractive index to air, it is possible to use not an expensive material but a general-purpose material (resin) as the high-refractive index resin.

### Embodiment 2

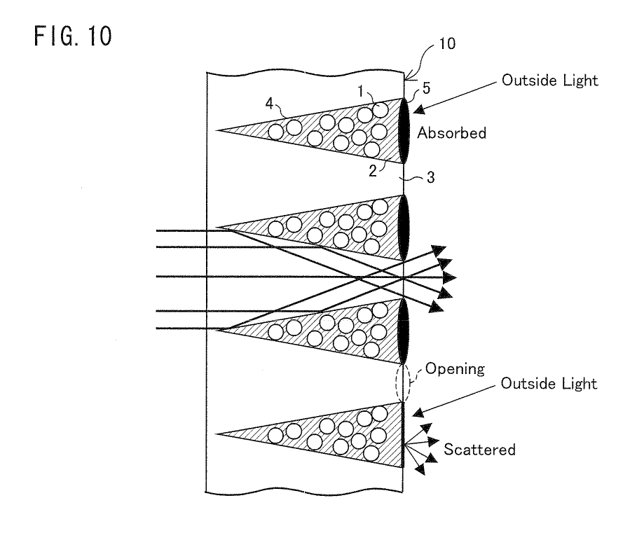

Another embodiment of an optical member 10 of the present invention is described below with reference to FIG. 10. For convenience of explanation, those members having the same functions as those shown in the drawings described above in Embodiment 1 are given the same referential signs and as such are not described below.

FIG. 10 is a cross-sectional view showing a configuration of an optical member 10 according to the present embodiment. As shown in FIG. 10, the optical member 10 according to the present embodiment has a light-absorbing layer 5 formed on a surface of the low-refractive-index region 2 opposite the plane of incidence. It should be noted that the arrows in FIG. 10 indicates the direction in which light travels.

The light-absorbing layer 5 is formed on such a bottom surface of the low-refractive-index region 2 as that shown in (a) through (d) of FIG. 6. This allows suppressing scattering of light and preventing a decrease in contrast ratio characteristic of a liquid crystal display device 20 including the optical member 10.

Examples of a material for the light-absorbing layer 5 include aqueous ink (paint) and oil ink (paint). Specifically, the material is obtained by adding a solvent and a pigment or a dye to a base resin.

Examples of the base resin include acrylic resin, urethane resin, melamine resin, etc.

Examples of the pigment or the dye include ivory black, aniline black, carbon black, lamp black, etc.

As an aqueous (hydrophilic) solvent, water or a hydrophilic organic solvent is used. Examples of hydrophilic organic solvents include formic acid, methanol, ethanol, 1-propanol, 2-propanol, 1-butanol, acetic acid, acetone, etc. Alternatively, as an oil (hydrophobic) solvent, a hydrophobic organic solvent is used. Examples of hydrophobic organic solvent include hexane, benzene, toluene, diethyl ether, chloroform, ethyl acetate, methylene chloride, etc.

The light-absorbing layer 5 is not limited to that described above as long as it is black. It is not necessary use black in one color, and it is possible to mix a red pigment, a green pigment, and a blue pigment to make black.

The light-absorbing layer 5 is formed on the optical member 10, for example, by applying, to a surface in which an opening is formed, paint that can be controlled by light to switch between being hydrophilic and being water-repellent (hydrophobic) and pattern-exposing a region to ultraviolet rays as needed. The ultraviolet-irradiated region loses its water repellency and improves its hydrophilicity with water. For example, in a case where only the bottom surface of the resin foam is irradiated with ultraviolet rays and a water-soluble absorbent is used in the opening, the water-repellent action of the paint allows the opening to repel water, so that, as shown in FIG. 10, the absorbent aggregates only on the bottom surface of the resin foam. Therefore, pattern irradiation with light allows the absorbent to be patterned in a self-alignment manner.

Examples of materials for achieving such a method of fabrication are shown, for example, in Japanese Patent Application Publication, Tokukai, No. 2004-146478, etc.

Alternatively, it is possible to use an oil-based absorbent instead of a water-based absorbent. In this case, the method of exposure may be achieved by pattern exposure with mask irradiation, but may also be achieved by exposure to a surface on which no pattern is formed. As shown in FIG. 10, light having entered through the surface on which no pattern is formed is totally reflected by the inner slopes to irradiate the opening. Such irradiation with ultraviolet rays prevents ultraviolet rays from striking the bottom surface of each wedge shape, thus allowing pattern exposure with the structure of the optical member without use of an exposure mask. In this state, each opening is irradiated with ultraviolet rays and therefore is low in water repellency and high in hydrophilicity. Use of an oil-based absorbent instead of a water-based absorbent in this state causes the absorbent to aggregate only on the bottom surface of each wedge shape, thus giving a desired light-blocking pattern.

### Embodiment 3

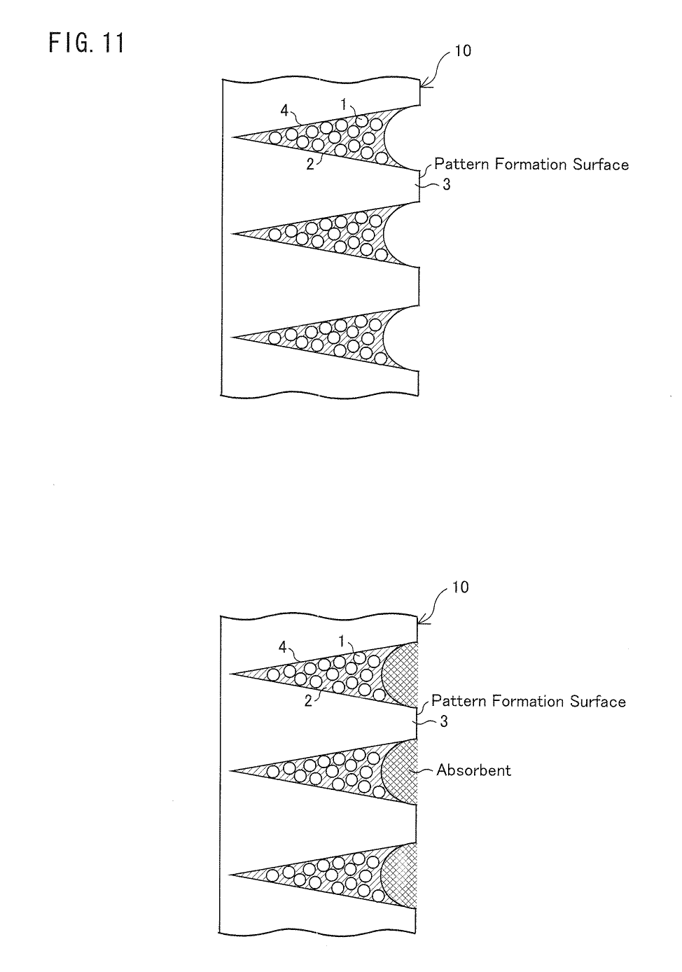

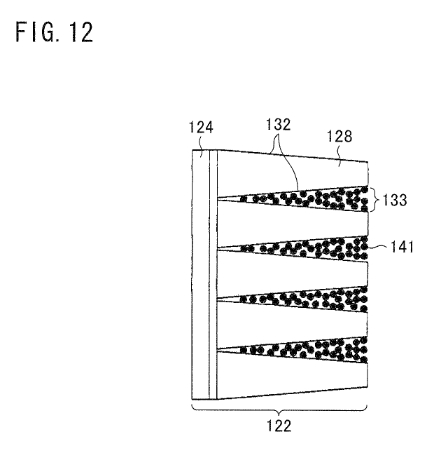

Another embodiment of an optical member 10 of the present invention is described below with reference to FIG. 11. For convenience of explanation, those members having the same functions as those shown in the drawings described above in Embodiment 1 are given the same referential signs and as such are not described below.

FIG. 11 is a cross-sectional view showing a configuration of an optical member 10 according to the present embodiment. As shown in FIG. 11, the optical member 10 according to the present embodiment is configured such that the resin is brought into contact with the foaming initiator on the interface 4 so that the surface of the low-refractive-index region 2 opposite to the plane of incidence is curved toward the plane of incidence. Further, the optical member 10 according to the present embodiment is configured such that resin foam is contained in the low-refractive-index region 2 so that the surface of the low-refractive-index region 2 opposite to the plane of incidence is curved toward the plane of incidence.

In the case of a process of foaming the resin after filling the low-refractive-index region with the resin, the foaming may cause an increase in volume of the resin, so that the resin protrudes from the pattern formation surface (surface opposite to the plane of incidence). This would make it more difficult to form a light-absorbing film. Further, lamination of a surface-treated film on the pattern formation surface in such a state causes a decrease in adhesion of the surface-treated film.

Such a problem can be eliminated by adjusting, in preparation in advance for an increase in volume of the resin due to foaming, the amount of the resin with which the low-refractive-index region is to be filled and bringing the resin into contact with the foaming initiator on the interface 4 so that the surface of the low-refractive-index region 2 opposite to the plane of incidence is curved toward the plane of incidence, i.e., is depressed below the pattern formation surface before foaming.

In so doing, the resin after foaming is preferably such that the low-refractive-index region 2 and the high-refractive-index region 3 are flush with each other on the pattern formation surface. However, the low-refractive-index region 2 and the high-refractive-index region 3 are not necessary flush with each other.

Further, even in the state in which the resin foam is contained in the low-refractive-index region 2 so that the surface of the low-refractive-index region 2 opposite to the plane of incidence is curved toward the plane of incidence, i.e., in the state in which the resin foam is depressed below the pattern formation surface after foaming, the depression can be alleviated by forming a light-absorbing layer. Furthermore, in the state in which the resin foam is contained in the low-refractive-index region 2 so that the surface of the low-refractive-index region 2 opposite to the plane of incidence is curved toward the plane of incidence, i.e., in the state in which the resin foam is depressed below the pattern formation surface after foaming, it is easy for the water-repellant liquid to aggregate on the bottom surface of the low-refractive-index region 2. This allows an improvement in pattern precision of the light-blocking layer (light-absorbing layer).

### Preferred Embodiments of the Present Invention

Further, the optical member of the present invention is preferably configured such that the second resin layer is lower in refractive index than the first resin layer.

With this, the optical member of the present invention makes it easy for the interface to totally reflect light incident on the interface from the plane of incidence. As a result, a liquid crystal display device including the optical member of the present invention can have an even larger viewing

Further, the optical member of the present invention is preferably configured such that the interface at least partly has a portion formed at an inclination of 6 to 21 degrees to a direction in which light entering through a plane of incidence travels. The reason for this is specifically explained below.

The upper limit for the inclination of the interface to the direction in which light entering through the plane of incidence travels (hereinafter also referred to simply as “upper limit”) is derived from conditions under which light having entered the optical member at an angle perpendicular to the plane of incidence and having been reflected by the interface is emitted from the first resin layer. Specifically, assuming that n1 is the refractive index of the resin contained in the first resin layer and θ is the angle of emission from the first resin layer (twice as large as the inclination of the interface, i.e., equal to the apex angle in a case where the second resin layer in the shape of a wedge), it is necessary to satisfy θ<sin(1/n1) according to the Snell's law in order that light given an inclination of θ by being reflected by the interface to be emitted from the first resin layer without total reflection. Obtaining θ on the assumption that n1 is the refractive index of 1.5 of a general-purpose resin gives θ=41.8 degrees. Therefore, when the upper limit for the clination of the interface is set to include up to this angle, the inclination of the interface is 21 degrees or smaller. It should be noted that when n1 becomes larger than 1.5, the inclination of light rays (i.e., which corresponds to θ) becomes smaller to fall within the above range (in which the inclination of the interface is 21 degrees or smaller).

On the other hand, the lower limit for the inclination of the interface to the direction in which light entering through the plane of incidence travels (hereinafter also referred to simply as “lower limit”) depends on the limit value of the shape of a turning tool for making a mold by cutting. As for the cutting limit of a turning tool, it is difficult to fabricate a turning tool with high accuracy unless the inclination is 6 degrees or larger and it is rare to fabricate a turning tool below the value; therefore, this value (6 degrees) serves as the lower limit.

This makes it easy for the optical member of the present invention to totally reflect light incident on the interface from the plane of incidence. As a result, a liquid crystal display device including the optical member of the present invention can have a larger viewing angle.

Further, the optical member of the present invention is preferably configured such that the second resin layer contains bubbles generated by bringing a resin into contact with a foaming initiator on the interface.

With this, the optical member of the present invention allows the foaming agent to selectively generate bubbles on the interface. As a result, the optical member of the present invention comes to have a difference in refractive index in a selected portion on the interface, so that light incident on the interface from the plane of incidence is totally reflected. This allows a liquid crystal display device including the optical member of the present invention to have a larger viewing angle.

Further, the optical member of the present invention is preferably configured such that the bubbles have a size of 10 μm or smaller.

With this, the optical member of the present invention allows the bubbles to be densely arrayed at the interface. As a result, the optical member of the present invention makes it easy for the interface to totally reflect light incident on the interface from the plane of incidence. This allows a liquid crystal display device including the optical member of the present invention to have a larger viewing angle.

Further, the optical member of the present invention is preferably configured to further include a light-absorbing layer formed on a surface of the second resin layer opposite to the plane of incidence.

With this, the optical member of the present invention allows the light-absorbing layer to suppress scattering of light (outside light). As a result, a liquid crystal display device including the optical member can prevent a decrease in contrast ratio characteristic.

Further, the optical member of the present invention is preferably configured such that the foaming initiator and the resin are in contact with each other on the interface in such a state that the surface of the second resin layer opposite to the plane of incidence is curved toward the plane of incidence.

This allows the optical member of the present invention to, in preparation in advance for an increase in volume of the resin due to the bubbles, adjust the amount of the resin with which the second resin layer is to be filled. This allows elimination of such a problem that an increase in volume of the resin due to the bubbles causes the resin to protrude from a pattern formation surface (surface opposite to the plane of incidence). As a result, the optical member of the present invention makes it easy to form the light-absorbing layer and makes it possible to improve adhesion of a surface-treated film to be described later.

Further, the optical member of the present invention is preferably configured such that the second resin layer exists in such a way that the surface of the second resin layer opposite the plane of incidence is curved toward the plane of incidence.

With this, the optical member of the present invention makes it easy to form the light-absorbing layer, thereby making it possible to improve pattern precision of the light-absorbing layer. As a result, a liquid crystal display device including the optical member can further prevent a decrease in contrast ratio characteristic.

Further, the optical member of the present invention is configured to further include a surface-treated film laminated on the surface opposite to the plane of incidence.

This allows a liquid crystal display device including the optical member of the present invention to have an even larger viewing angle.

Further, a liquid crystal display device of the present invention include such an optical member.

This allows the liquid crystal display device of the present invention to be fabricated at lower cost and to have a larger viewing angle.

Further, a liquid crystal display device of the present invention is preferably configured such that the optical member comprises a plurality of optical members.

This allows the liquid crystal display device of the present invention to improve viewing angle characteristics in all directions even in a case where each of the optical members has a direction in which light is not scattered.

(Others)

It should be noted that an optical member according to the present invention may be configured, for example, such that resin foam is used as a low-refractive-index section.

Further, the optical member according to the present invention may be configured, for example, such that the interface between the low-refractive-index section and the high-refractive-index section is selectively foamed.

Further, the optical member according to the present invention may be configured, for example, such that the resin foam used has a bubble size of several micrometers or smaller or, preferably, a bubble size of 1 μm or smaller.

Further, the optical member according to the present invention may be configured, for example, such that a light-absorbing layer can be patterned in a self-alignment manner with use of a water-repellant coating film.

Further, the optical member according to the present invention may be configured, for example, to be filled with a resin before foaming in such a state that a wedge portion is depressed.

Further, the optical member according to the present invention may be configured, for example, to be filled with a resin after foaming in such a state that a wedge portion is depressed.

The present invention is not limited to the description of the embodiments above, but may be altered by a skilled person within the scope of the claims. An embodiment based on a proper combination of technical means disclosed in different embodiments is encompassed in the technical scope of the present invention.

The embodiments and concrete examples of implementation discussed in the foregoing detailed explanation serve solely to illustrate the technical details of the present invention, which should not be narrowly interpreted within the limits of such embodiments and concrete examples, but rather may be applied in many variations within the spirit of the present invention, provided such variations do not exceed the scope of the patent claims set forth below.

### INDUSTRIAL APPLICABILITY

A liquid crystal display device including an optical member of the present invention makes it possible to achieve a less-restricted viewing angle, which was impossible with a conventional liquid crystal display device.

Therefore, optical members of the present invention can be used in fields where viewing angles are required, e.g., information displays, monitors at broadcasting stations, monitors for medical use, digital photo frames, etc.

### REFERENCE SIGNS LIST

1 Bubble

2 Second resin layer (low-refractive-index region)

3 First resin layer (high-refractive-index region)

4 Interface

5 Light-absorbing layer

10 Optical member

11 Surface-treated film

12 Substrate

13 Liquid crystal display element

20 Liquid crystal display device

1. An optical member comprising at least:
a first resin layer; and
a second resin layer,
the second resin layer containing bubbles, the bubbles being present at least at an interface between the first resin layer and the second resin layer.

2. The optical member as set forth in claim 1, wherein the second resin layer is lower in refractive index than the first resin layer.

3. The optical member as set forth in claim 1, wherein the interface at least partly has a portion formed at an inclination of 6 to 21 degrees to a direction in which light entering through a plane of incidence travels.

4. The optical member as set forth in claim 1, wherein the second resin layer contains bubbles generated by bringing a resin into contact with a foaming initiator on the interface.

5. The optical member as set forth in claim 1, wherein the bubbles have a size of 10 μm or smaller.

6. The optical member as set forth in claim 1, further comprising a light-absorbing layer formed on a surface of the second resin layer opposite to the plane of incidence.

7. The optical member as set forth in claim 4, wherein the foaming initiator and the resin are in contact with each other on the interface in such a state that the surface of the second resin layer opposite to the plane of incidence is curved toward the plane of incidence.

8. The optical member as set forth in claim 1, wherein the second resin layer exists in such a way that the surface of the second resin layer opposite the plane of incidence is curved toward the plane of incidence.

9. The optical member as set forth in claim 1, further comprising a surface-treated film laminated on the surface opposite to the plane of incidence.

10. A liquid crystal display device comprising an optical member as set forth in claim 1.

11. The liquid crystal display device as set forth in claim 10, wherein the optical member comprises a plurality of optical members.
